(19) United States
(12) Patent Application Publication
(10) Pub. No.: US 2006/0271975 A1
(43) Pub. Date: Nov. 30, 2006

(54) Time-shifting audio and video programs

(76) Inventors: Edmund Sun, Atherton, CA (US); Stephen Purcell, Mountain View, CA (US); Wai-Ting Chen, Taipei (TW)

Correspondence Address: FISH & RICHARDSON P.C., PO BOX 1022, MINNEAPOLIS, MN, 55440-1022, US

(21) Appl. No.: 11/135,755

(22) Filed: May 23, 2005

(51) Int. Cl. H04N 7/173; G06F 3/00; H04N 5/445

(52) U.S. Cl. 725/87; 725/61; 725/86

(57) ABSTRACT

Methods and apparatus, including computer program products, for recording and replaying audio and video programs. A device includes a video input controller, a video output controller, a command interface, a network adapter, and control circuitry. The video input controller receives an audiovisual program. The video output controller is operable to output a video signal representing the audiovisual program. The command interface is operable to receive input requesting that the audiovisual program be recorded. The network adapter is operable to connect the device to a data communication network, where the device is addressable over the data communication network through the network adapter. The control circuitry can receive the input requesting that the audiovisual program be recorded. The control circuitry can cause the requested audiovisual program to be transmitted to a remote storage device over the data communication network through the network adapter and to be recorded at the remote storage device.

### BACKGROUND

The present invention relates to electronic recording and playback devices, and more particularly to devices that can be used to record and replay audio and video programs such as movies, concerts, sporting events, or television shows (generically referred to as “audiovisual programs.”)

Cable and satellite content providers conventionally have provided audio/video programs in the form of analog signals using various delivery methods. These delivery methods typically require the cable or satellite provider to provide a set top box capable of enabling a user to select a specified program from among a variety of programs delivered to the set top box, and display the selected program on the television set connected to the set top box. In addition, the user can record the selected program using a recording device, such as a videocassette recorder (VCR) or digital video recorder (DVR).

At the present, cable and satellite providers are moving to the delivery of programs in digital formats. These digital programs typically are delivered to digital set top boxes that are capable of selecting and displaying a user specified program from among a variety of programs being delivered. For example, audiovisual programs can be conveyed in a digital format that conforms to industry standards. Such industry standards include, Motion Picture Expert Group-2 (MPEG-2) transport streams, Direct TV transport streams, Digital Video Broadcasting (DVB) transport streams, or Digital Video (DV) streams.

### SUMMARY OF THE INVENTION

The present invention provides methods and apparatus, including computer program products, that implement techniques for recording and replaying audiovisual programs.

In one general aspect, the techniques feature a device including a video input controller, a video output controller, a command interface, and a network adapter. The video input controller is operable to receive a audiovisual program that is a live broadcast program. The video output controller is coupled to communicate with the video input controller, and the video output controller is operable to output a video signal representing the audiovisual program. The command interface is operable to receive input requesting that the audiovisual program be recorded. The network adapter is operable to connect the device to a data communication network, where the device is addressable over the data communication network through the network adapter. The device includes control circuitry coupled to communicate with the video input controller, the video output controller, the command interface, and the network adapter. The control circuitry is operable to receive the input requesting that the audiovisual program be recorded. The control circuitry is further operable to cause the requested audiovisual program to be transmitted to a remote storage device over the data communication network through the network adapter and to be recorded at the remote storage device.

Implementations of the invention can include one or more of the following features. The device can be operable to receive a network request over the data communication network through the network adapter, where the network request is a request to record the audiovisual program. The command interface can be further operable to receive input requesting that an audiovisual program stored at the remote storage device be replayed, and the control circuitry can be operable to replay the stored audiovisual program from the remote storage device over the data communication network through the network adapter. The control circuitry can transmit the requested audiovisual program to the remote storage device using a network file sharing protocol. The network file sharing protocol can be a file transfer protocol, a server message block protocol, or a network file server protocol. The remote storage device can be selected from one or more remote storage devices. The remote storage device can be selected from one or more remote storage devices based on available storage capacity, or assigned priorities. The device can include a solid state memory adapter operable to receive a solid state memory device, where the solid state memory adapter is operable to record the requested audiovisual program at the solid state memory device through the solid state memory adapter. The solid state memory adapter can be operable to receive a removable solid state memory device. The device can include a cellular telephone or a television. The data communication network can include a local area network or a wide area network. The data communication network can include a wireless network or a wired network.

In another aspect, the techniques feature a system including a first network addressable device, a second network addressable device, a remote storage device, and a data communication network. The remote storage device is remote from the first and second network addressable device, and the first and second network addressable devices are addressable over the data communication network. The first network addressable device includes a first video input controller that can receive an audiovisual program, a first video output controller coupled to communicate with the first video input controller, a first command interface operable to receive input requesting that the audiovisual program be recorded, and a first network adapter operable to communicate an instruction to record the requested audiovisual program. The first video output controller is operable to output a first video signal representing the audiovisual program. The first network addressable device includes a first control circuitry coupled to communicate with the first video input controller, the first video output controller, the first network adapter, and the first command interface. The second network addressable device is operable to receive the audiovisual program, and the second network addressable device includes a second network adapter and a second control circuitry coupled to communicate with the second network adapter. The second control circuitry is operable to receive the instruction to record the requested audiovisual program from the first network device through the second network adapter. The first control circuitry is operable to cause the requested audiovisual program to be transmitted to the remote storage device over the data communication network through the first network adapter and to be recorded at the remote storage device. The first control circuitry is further operable to forward the input request for recording the audiovisual program to the second network addressable device, where the second control circuitry is operable to receive the input request for recording the requested audiovisual program and record the requested audiovisual program at the remote storage device, in response to the input request.

Implementations of the invention include one or more of the following features. The first command interface can be operable to receive input requesting that an audiovisual program stored at the remote storage device be replayed. The first control circuitry can be operable to replay the stored audiovisual program from the remote storage device over the data communication network through the first network adapter.

In another aspect, the techniques feature receiving command input to record a requested audiovisual program at a first device, determining whether to use the first device or a second device to record the requested audiovisual program, and selecting one remote storage device from one or more remote storage devices. The requested audiovisual program is one of one or more audiovisual programs received at the first device. The remote storage device is remote from the first device. The first device has a first network adapter, and the first device is operable to communicate with the selected remote storage device through the network adapter. If the first device is used to record the requested audiovisual program, at least a portion of the requested audiovisual program is recorded at the selected remote storage device using the first device. If a second device is used to record the requested audiovisual program, the second device is selected from one or more remote devices that are remote from the first device. The second device has a second network adapter, and the first device is operable to communicate the command input with the second device through the first network adapter and the second network adapter. The techniques include recording at least a portion of the requested audiovisual program at the selected remote storage device using the second device, if the second device is used to record the requested audiovisual program.

Implementations of the invention include one or more of the following features. The remote storage device can be remote from the second device, and the second device can be operable to communicate with the selected remote storage device through the network adapter. Recording at least a portion of the requested audiovisual program can include, receiving the requested audiovisual program, encoding the requested audiovisual program into a compressed digital format, and storing the requested audiovisual program in compressed format as one or more files. Recording at least a portion of the requested audiovisual program can include, transmitting the portion of the requested audiovisual program to the selected remote storage device using a network file sharing protocol, and storing the requested audiovisual program at the selected remote storage device. The network file sharing protocol can be a file transfer protocol, a server message block protocol, or a network file server protocol. The remote storage device can be selected by the first device or the second device. Selecting the remote storage device can include, selecting the remote storage device from the one or more remote storage devices based on available storage capacity for recording the requested audiovisual program. The one or more remote storage devices can have assigned priorities, and selecting the remote storage device can include selecting the remote storage device having the highest priority.

The invention can be implemented to realize one or more of the following advantages. The program access device can communicate with a group of one or more remote storage devices using the data communication network and it can record the requested audiovisual program at the remote storage devices. The program access device can record the requested audiovisual program as one or more files that are stored at the group of remote storage devices. The files corresponding to the requested audiovisual program can be stored at one or more of the remote storage devices in the group of remote storage devices. A group of one or more remote storage devices can be initially selected for recording the requested audiovisual program, and additional remote storage devices can be selected for recording the requested audiovisual program if additional storage capacity is required for recording. The program access device can replay a stored audiovisual program stored at the group of remote storage devices and display it using the display controller. The program access can replay a stored audiovisual program that is stored at more than one remote storage device. The program access device can communicate with a group of one or more remote program access devices using the data communication network. If the program access device does not have available resources for recording the requested audiovisual program, the program access device selects a remote program access device in the group of remote program access devices, and uses the selected remote program access device for recording the requested audiovisual program, where the selected remote program access device has available resources for recording the requested audiovisual program. The selected remote program access device can record the requested audiovisual program at one or more selected remote storage devices. If the program access device has a solid state memory adapter that can receive a solid state memory device, the solid state memory device can be used for time-shifting the requested audiovisual program. One implementation of the invention provides all of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1A illustrates an environment including a program access device connected to a remote storage device.

FIG. 1B illustrates an alternative environment including a program access device connected to a group of remote storage devices.

FIG. 1C illustrates an environment including a program access device connected to a group of remote program access devices.

FIG. 2A is a block diagram illustrating one implementation of the program access device.

FIG. 2B is a block diagram illustrating an alternative implementation of the program access device including an adapter for solid state memory.

FIG. 3 illustrates a method for recording a requested audiovisual program at a remote storage device.

FIG. 4 illustrates a method for replaying an audiovisual program stored at the remote storage device.

FIG. 5 illustrates a method for recording a requested audiovisual program at a remote storage device in a group of remote storage devices.

FIG. 6 illustrates a method for replaying an audiovisual program stored at the group of remote storage devices.

FIG. 7 illustrates a method for recording a requested audiovisual program using a remote program access device in a group of remote program access devices.

FIG. 8 is a block diagram illustrating one implementation of a cellular telephone using the program access device.

Like reference numbers and designations in the various drawings indicate like elements.

### DETAILED DESCRIPTION

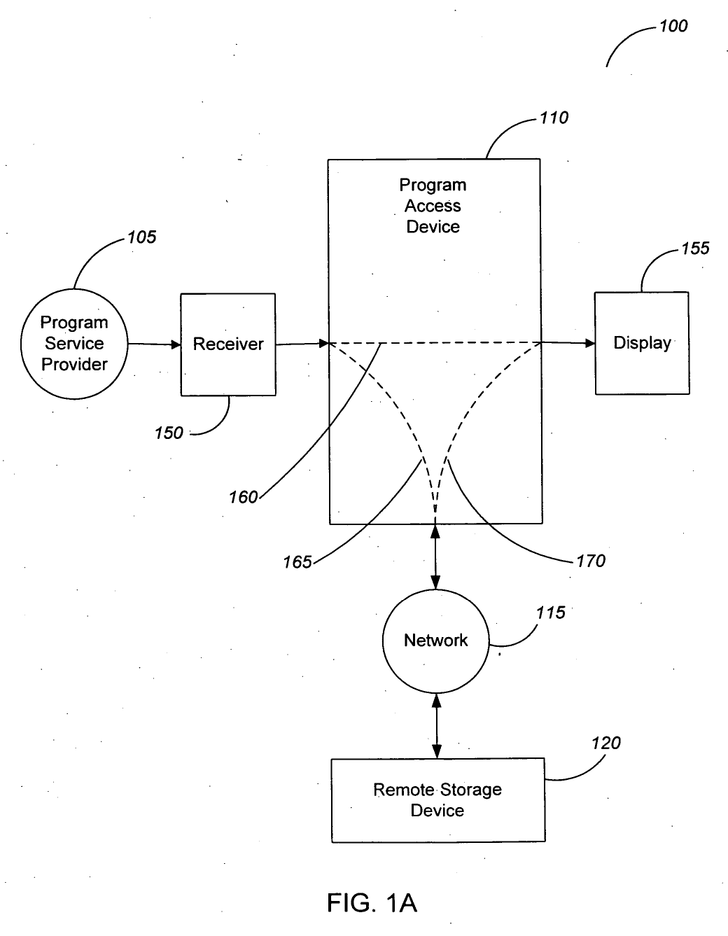

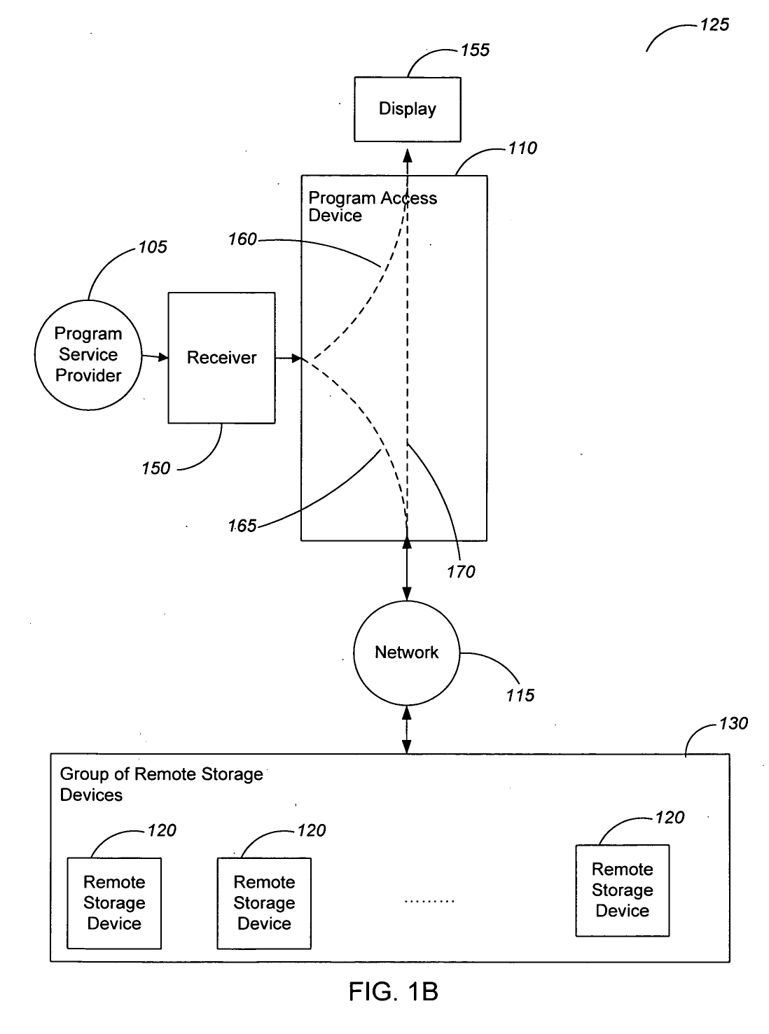

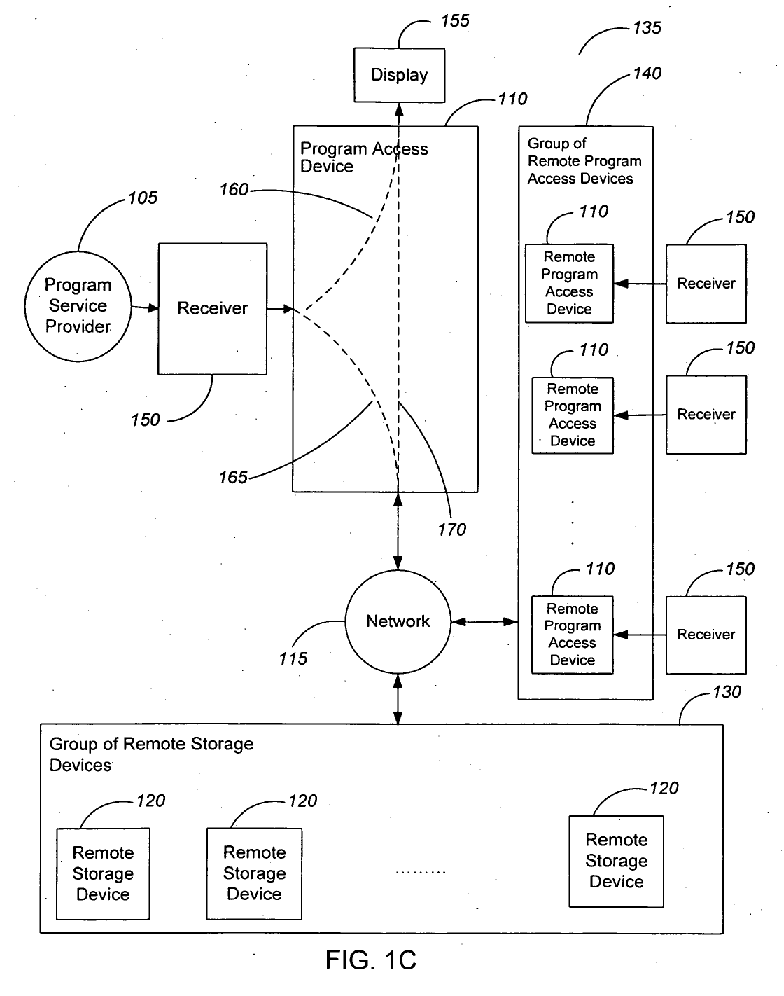

The systems and techniques described in this specification can be implemented, for example, in an environment 100 illustrated in FIG. 1A that includes a program access device 110 operable to communicate with a remote storage device 120 using a data communication network 115. The program access device receives one or more audiovisual programs from a program service provider 105 using a receiver 150. The program service provider transmits one or more audiovisual programs to the receiver using a cable network, a satellite network, or a terrestrial network. The audiovisual programs received by the program access device are extracted by the receiver from one of the audiovisual programs transmitted by the program service provider.

The program access device can record one or more of the received audiovisual programs at the remote storage device 120 (link 165). The program access device can also replay a stored audiovisual program that is stored at the remote storage device 120, at a display device 155 (link 170). In addition, the program access device can display one or more of the received audiovisual programs at the display device 155 live, i.e., as the audiovisual programs are received, without storing them at the remote storage device (link 160). Typically, a user interacting with the program access device specifies the audiovisual program to be recorded using the program access device and the stored audiovisual program to be retrieved using the program access device. In one implementation, the program access device receives the user commands from a graphical user interface.

Remote devices connected to the program access device using the data communication network include, remote storage devices, remote program access devices, computers, network switches, and routers. The remote storage device is any storage device that can be accessed using the data communication network, e.g., a networked hard drive, or a hard drive of a networked computer. The data communication network can be a local area network or a wide area network, or a combination. In addition, the data communication network can be a wired network (e.g., an Ethernet network) or a wireless network (e.g., a WiFi network, or a Bluetooth network), or a combination. The program access device can use a combination of data communication networks to connect to the remote devices, e.g., the program access device can connect to remote program access devices using a Bluetooth network and it can connect to remote storage devices using a WiFi network.

The program access device communicates with the remote storage device using a network file sharing protocol. The network file sharing protocol is a network protocol that provides a command structure for file requests between the program access device and the remote storage device including commands for opening, reading, writing, and closing files over the data communication network. The network file sharing protocol can also provide access to directory services. Examples of the network file sharing protocol include, a file transfer protocol (FTP), a server message block protocol (SMB), and a network file server protocol (NFS).

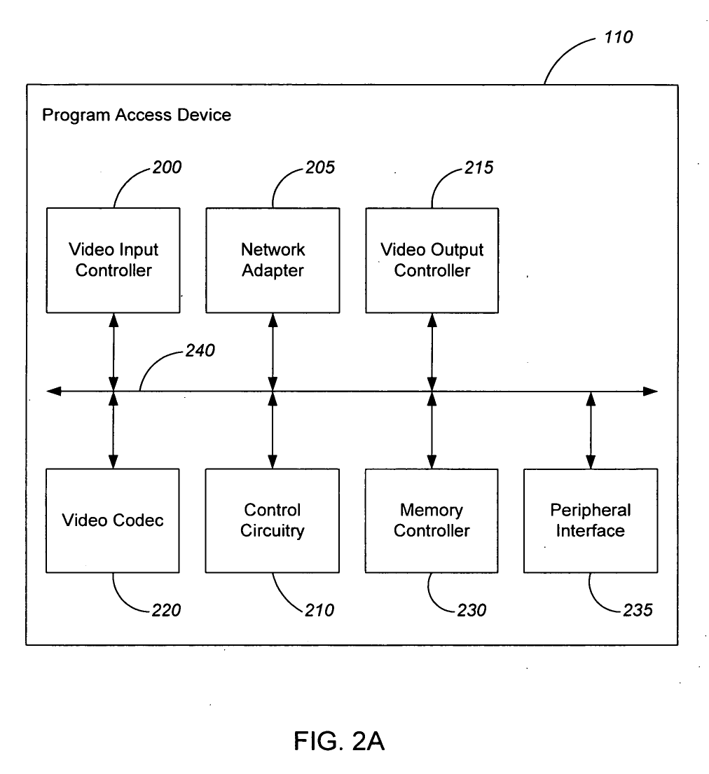

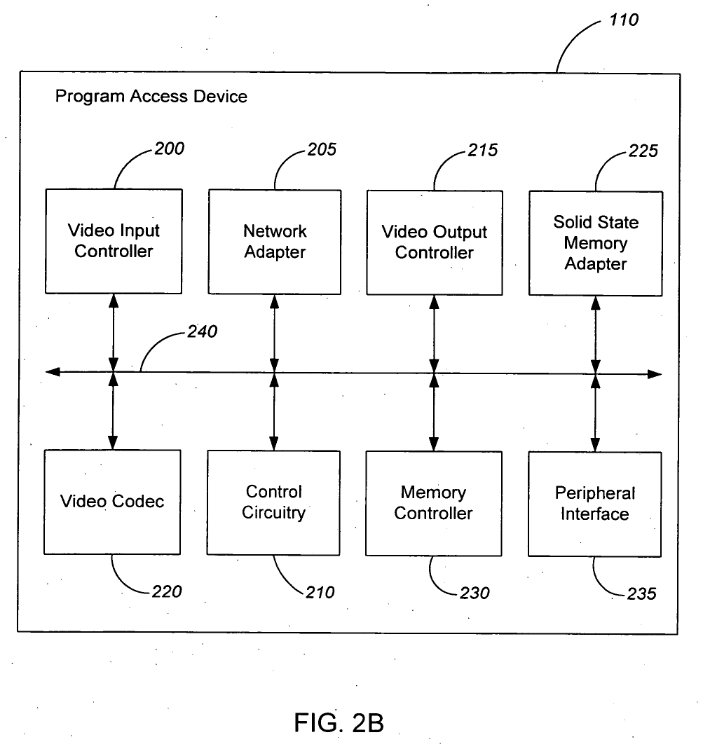

FIG. 2A is a block diagram illustrating one implementation of the program access device 10. Functional blocks of the program access device includes a video input controller 200, a video output controller 215, and a network adapter 205. The video input controller receives audiovisual programs in either analog video format (e.g., composite video, or S-video format) or digital video format. The digital video format received by the video input controller can be either an uncompressed digital video format (e.g., CCIR 601, or CCIR 656 format) or a compressed digital video format (e.g., an MPEG transport stream, or a DVB transport stream). If the audio program received by the video input controller is in analog video format, the video input controller converts the received audiovisual program to a digital video format. The video output controller 215 receives a video signal in uncompressed digital video format and generates a video output signal in either analog video format or digital video format. The video output signal generated by the video output controller can be communicated to a display device that can display the video output signal, e.g., a digital television, an analog television, or a liquid crystal display. The video output controller can perform post-processing on the received video signal before generating the video output signal, e.g., horizontal scaling, vertical scaling, de-interlacing, and picture-in-picture (PIP). The network adapter is used to connect the program access device to the data communication network, and allows the program access device to communicate with other devices connected to the data communication network. The program access device is addressable over the data communication network using the network adapter.

The program access device also includes a video codec 220, control circuitry 210, a memory controller 230, and a peripheral interface 235. The video codec 220 is used to encode audiovisual programs in the uncompressed digital or analog video format to the compressed digital video format, and to decode audiovisual programs in the compressed digital video format to the uncompressed digital video format. The video codec is also used to transcode audiovisual programs from a compressed digital format to an alternative compressed digital format, e.g., an alternative compressed digital format having a different syntax, compression ratio, or average number of bits per second. The control circuitry is used to implement a user interface that receives commands from a user, and to control the operation of the program access device to implement the user commands. In one implementation an external device (i.e., external to the program access device) implements the user interface, and the control circuitry implements a command interface that receives input requests from the external user interface. The memory controller is used to interface the program access device to external memory that is used to implement the user commands. The peripheral interface is used to connect the program access devices to peripheral devices, e.g., keyboard, mouse, tablet, printer, peripherals having a Universal Serial Bus (USB) or fire wire interface, and storage devices.

The program access device includes at least one local bus 240 that is used to communicate between the functional blocks. The local bus is used to communicate data between the functional blocks. The local bus is also used by a functional block to control the operation of one or more other functional blocks, e.g., by transmitting commands or control information to the other functional blocks.

In one implementation, the control circuitry controls the operation of the program access device functional blocks to implement a time-shift engine. Control circuitry can include hardware, software, firmware, microcode, microprocessor, digital signal processor, or a combination of two or more of these. The time-shift engine records a received audiovisual program to a remote storage device, and replays a stored audiovisual program stored at a remote storage device. In addition, the time-shift engine can also be used to implement a pause feature that allows the user to pause a live audiovisual program (i.e., a received audiovisual program that is being viewed as it is received), and resume a previously paused live audiovisual program. In order to pause and resume a live audiovisual program, the time-shift engine starts recording the live audiovisual program after it receives a pause request from the user. In response to a user request to resume the previously paused audiovisual program, the time-shift engine starts replaying the recorded audiovisual program and continues to record the live audiovisual program as it is received.

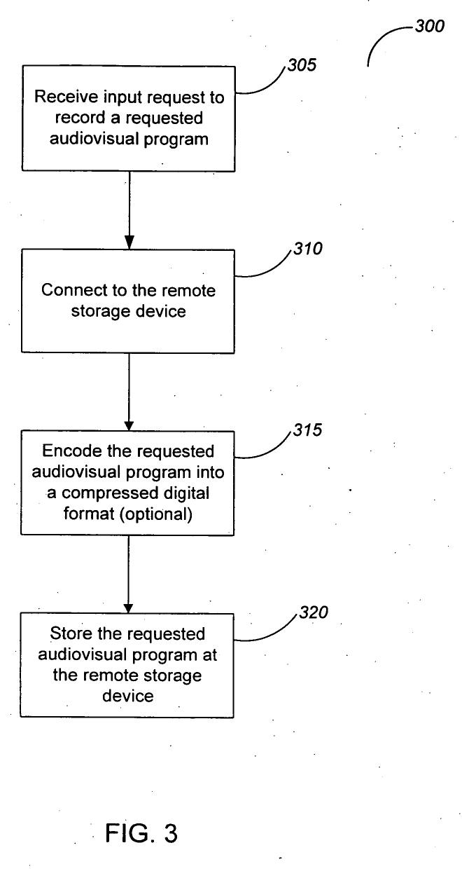

FIG. 3 illustrates a method 300 for recording a requested audiovisual program. The program access device receives an input request to record a requested audiovisual program that is being received (step 305). Typically, the requested audiovisual program is a live video broadcast. The program access device connects to the remote storage device using the network adapter (step 310). The requested audiovisual program is optionally encoded into a compressed digital format (step 315), and stored at the remote storage device (step 320). The encoding step is not performed for audiovisual programs that are stored in the format in which they are received.

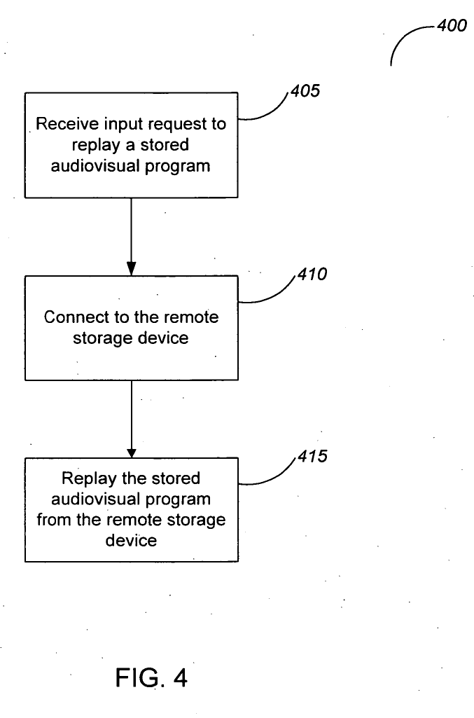

FIG. 4 illustrates a method 400 for replaying an audiovisual program stored at the remote storage device. The program access device receives an input request to replay a stored audiovisual program (step 405). The program access device connects to the remote storage device using the network adapter (step 410), and replays the stored audiovisual program from the remote storage device (step 415). Replaying the stored audiovisual program includes retrieving the stored audiovisual program from the remote storage device, and generating a video output signal using the video output controller. In addition, if the stored audiovisual program is in a compressed digital format, replaying the stored audiovisual program includes decoding the stored audiovisual program to convert it from the compressed digital format to an uncompressed digital format that can be processed by the video output controller.

FIG. 1B illustrates an alternative environment 125 in which a group 130 of one or more remote storage devices 120 are connected to the program access device 110 using the data communication network 115. In this environment, the program access device records the requested audiovisual program at a remote storage device 120 in the group 130 of remote storage devices. In addition, the program access device can replay a stored audiovisual program that is stored at any remote storage device 120 in the group 130 of remote storage devices.

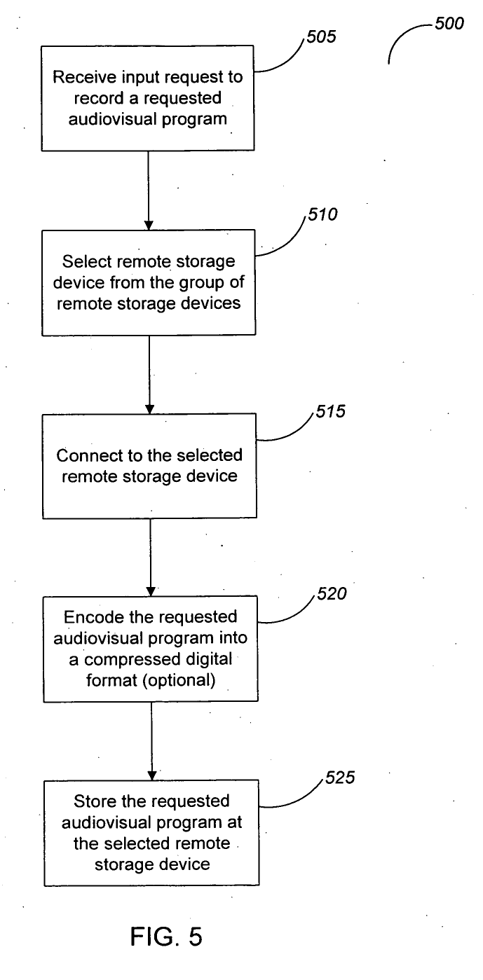

FIG. 5 illustrates a method 500 for recording a received audiovisual program using the group of remote storage devices. The program access device receives an input request to record a requested audiovisual program (step 505), and selects a remote storage device from the group of remote storage devices based on predetermined criteria (step 510). The program access device connects to the selected remote storage device using the network adapter (step 515). The requested audiovisual program is optionally encoded into a compressed digital format (step 520) before it is stored at the selected remote storage device (step 525). The encoding step is not performed for audiovisual programs that are stored in the format in which they are received.

The predetermined criteria for selecting a remote storage device in the group of remote storage devices include user defined preferences, assigned priorities for the remote storage devices, and available storage capacity at the remote storage device. In one implementation, the selected remote storage device is a remote storage device that has sufficient available storage capacity for storing the requested audiovisual program. In alternative implementations, the remote storage devices can have assigned device priorities, e.g. a remote storage device that is more proximate to the program access device is assigned a higher priority, and selected remote storage device is the highest priority remote storage device that has available storage capacity for storing the requested audiovisual program. In other implementations, the priorities for the remote storage devices can be specified by a user.

The requested audiovisual program can be stored either as a single file or as a collection of several files that must be played in a specified sequence to replay the audiovisual program. In one implementation, the file size of each file in the collection of files is determined by the available storage capacity of the remote storage device being used to store the corresponding file. For example, a first remote storage device is selected for storing a first file, and after the storage capacity of the first remote storage device is exhausted a second remote storage device is selected for storing a second file, and the process is continued until the entire requested audiovisual program has been recorded.

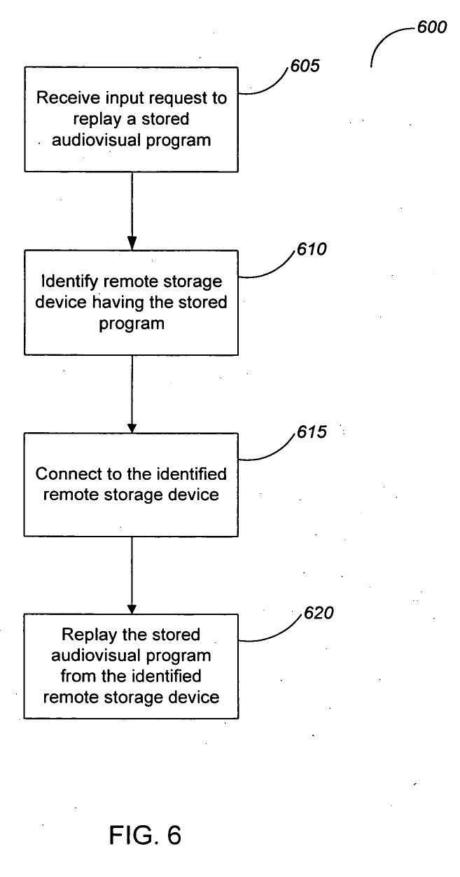

FIG. 6 illustrates a method 600 for replaying an audiovisual program stored at the group of remote storage devices. The program access device receives an input request to replay a stored audiovisual program (step 605) that is stored at one of the remote storages devices in the group of remote storage devices. The program access device identifies a remote storage device (in the group of remote storage devices) having the stored audiovisual program (step 610). The program access device connects to the identified remote storage device using the network adapter (step 615), and replays the stored audiovisual program from the identified remote storage device (step 620). Replaying the stored audiovisual program includes retrieving the stored audiovisual program from the remote storage device, and displaying it on either the integrated display device or the external display device. In addition, if the stored audiovisual program is in a compressed digital format, replaying the stored audiovisual program includes decoding the stored audiovisual program to convert it from the compressed digital format to an uncompressed format that can be displayed on a display device.

FIG. 1C illustrates an alternative environment in which the program access device can communicate with a group 140 of one or more remote program access devices 110 using the data communication network 115. In this environment, the program access device can utilize any available remote program access device in the group of remote program access devices to record a requested audiovisual program. Typically, the program access device utilizes the remote program access devices in the group to record a requested audiovisual program because the resources of the program access device (e.g., receiver, and video codec) are unavailable for recording. For example, if the receiver at the program access device is currently extracting a maximum number of audiovisual programs that it can extract, the receiver at the program access device would not be available to extract the requested audiovisual program and one of the remote program access devices would be utilized to extract the requested audiovisual program. In this environment, the program access device records the extracted audiovisual program at any one of the one or more remote storage devices 120 in the group 130 of remote storage devices. In addition, the program access device can replay a stored audiovisual program that is stored at any remote storage device 120 in the group 130 of remote storage devices.

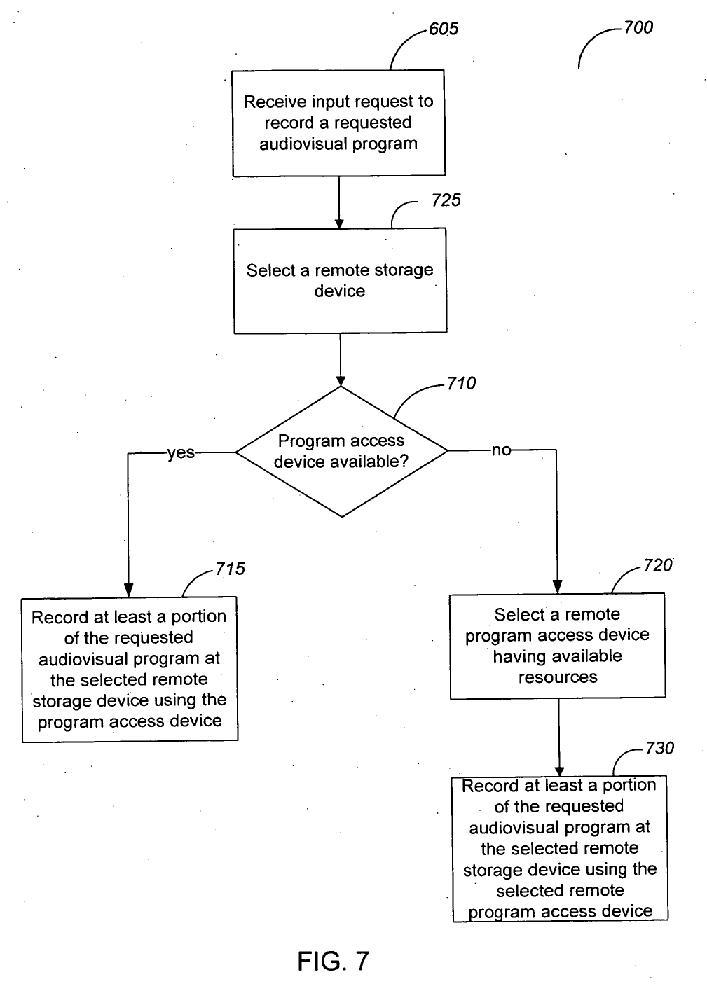

FIG. 7 illustrates a method 700 for recording a received audiovisual program using the group of remote program access devices. The program access device receives an input request to record a requested audiovisual program (step 705), and selects a remote storage device from the group of remote storage devices (step 725) If the program access device is available to record the requested audiovisual program (“yes” branch of decision step 710), at least a portion of the requested audiovisual program is recorded at the selected remote storage device using the receiver at the program access device, e.g., by using the methods described above with reference to FIG. 3 and FIG. 5 (step 715). If the program access device is not available to record the requested audiovisual program (“no” branch of decision step 710), a remote program access device is selected from the group of remote program access devices, where the selected remote program access device has a receiver that is available for recording the requested audiovisual program (step 720), and at least a portion of the requested audiovisual program is recorded at the selected remote storage device using the receiver at the selected remote program access device (step 730).

The remote program access device can be selected automatically, or it can be selected based on user specified preferences. The requested audiovisual program is optionally encoded into a compressed digital video format before it is stored. The remote storage device is selected either by the program access device or by the selected remote program access device. The remote storage access device can be selected automatically based on predetermined criteria, such as available storage capacity or assigned priorities. The remote program access device can also be selected based on user specified preferences. In one implementation, the requested audiovisual program is stored at the selected remote storage device directly by the selected remote program access device. In an alternative implementation, the selected remote program access device transmits the requested audiovisual program to the program access device (after optionally encoding it into a compressed digital video format) and program access device stores the requested audiovisual program at the selected remote storage device. The selected remote storage device can also be a device that is remote from the program access device, but is not remote from the selected remote program access device.

The requested audiovisual program can be recorded as one or more portions. In one implementation, all the recorded portions are stored at one remote storage device. In alternative implementations the recorded portions are stored at one or more of the remote storage devices in the group of remote storage devices. Each recorded portion can be stored as one or more files. Alternatively, the requested video program can be recorded as one or more files, and each recorded portion can correspond to a portion of a file of the one or more files.

FIG. 2B is a block diagram illustrating an alternative implementation of the program access device 110, which includes a solid state memory adapter 225 that can receive a solid state memory 230. The solid state memory is used by the time-shift engine to record an audiovisual program, and replay an audiovisual program stored at the solid state memory. Typically, the solid state memory is used by the time-shift engine to store an audiovisual program for a short duration of time because the total storage capacity of the solid state memory is smaller than the total storage capacity that is available at the remote storage devices. In one implementation, the solid state memory is used by the time-shift engine to implement a pause feature that permits the user to pause the display of a received audiovisual program for a short duration of time and then return to watching the received audiovisual program. In an alternative implementation, the solid state memory is used by the time-shift engine as a temporary memory buffer to store the requested audiovisual program to be recorded at a remote storage device for a short duration of time. For example, the solid state memory is used as a temporary buffer to reduce the number of read and write accesses to the remote storage device, or to store the requested audiovisual program while the remote storage device is not available for read and write accesses.

Solid state memories received by the solid state memory adapter can include different types of memories dynamic random access memory (DRAM), static random access memory (SRAM), or flash memory. The solid state memory adapter can also receive memories having different physical dimensions, e.g., CompactFlash cards, SmartMedia cards, SecureDigital cards, etc. For example, the solid state memory adapter can have one or more slots that are used to plug-in removable memory cards of different types and physical dimensions.

In one implementation, the program access device includes two separate memory adapters, a DRAM adapter for receiving DRAM, and a flash adapter for receiving flash memory. In this implementation, the number of write cycles to the flash memory is reduced by using the DRAM to implement a write buffer that is used to accumulate a portions of the requested audiovisual program, and subsequently writing the accumulated portions to the flash memory.

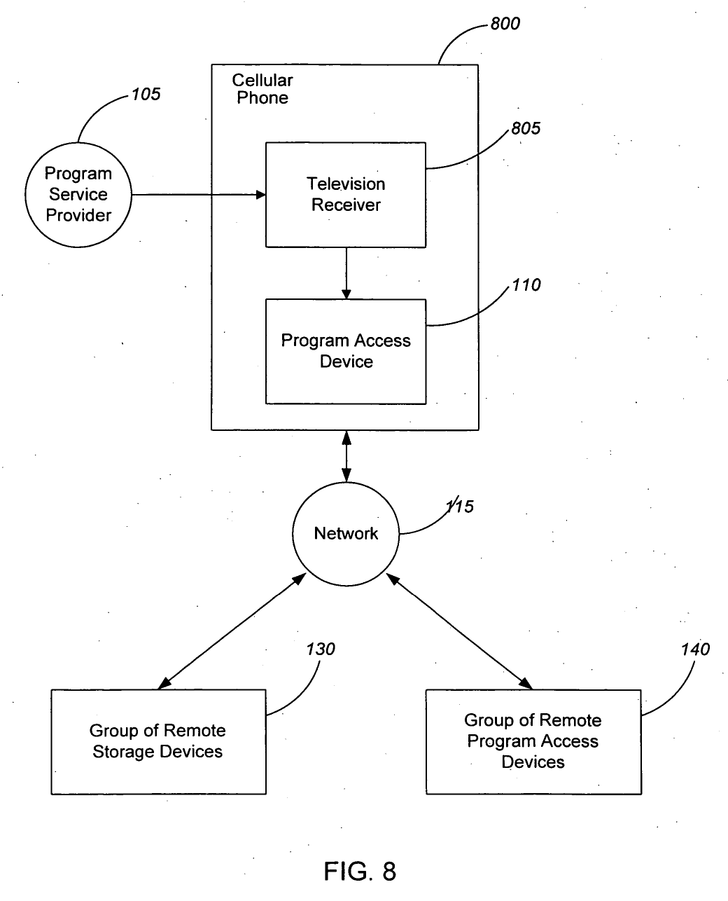

FIG. 8 is a block diagram illustrating one implementation of a cellular telephone 800 using the program access device. The cellular telephone includes a television receiver 805, in addition to the program access device 110. The cellular telephone receives audiovisual programs from the program service provider 105 using the television receiver, and transmits a requested audiovisual program to the program access device in response to a user input request. The program access device is operable to connect to the group of one or more remote storage devices 130, and the group of one or more remote program access devices 140 using the data communication network 115. Using the methods and techniques described above the cellular telephone can record the requested audiovisual program at one or more selected remote storage devices of the group of remote storage devices. In addition, the cellular telephone can record the requested audiovisual program using a selected remote program access device of the group of one or more remote program access devices. In one implementation, the cellular telephone does not include a television receiver, and always records the requested audiovisual program using a selected remote program access device. The cellular telephone can also be used to replay a stored audiovisual program that is stored at the group of the group of remote storage devices. In one implementation, the cellular telephone includes a solid state memory adapter operable to receive removable solid state memory that can be used to pause a live audiovisual program being viewed by the user, or to record the requested audiovisual program. The program access device can also be included in a television set, or a set-top box, or a remote storage device.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The invention has been described in terms of particular embodiments, but other embodiments can be implemented and are within the scope of the following claims. For example, the operations of the invention can be performed in a different order and still achieve desirable results. Other embodiments are within the scope of the following claims

What is claimed is:

1. A device, comprising:
a video input controller operable to receive an audiovisual program, the audiovisual program being a live broadcast program;
a video output controller coupled to communicate with the video input controller, the video output controller being operable to output a video signal representing the audiovisual program;
a command interface operable to receive input requesting that the audiovisual program be recorded;
a network adapter operable to connect the device to a data communication network, the device being addressable over the data communication network through the network adapter; and
control circuitry coupled to communicate with the video input controller, the video output controller, the command interface, and the network adapter, the control circuitry being operable to receive the input requesting that the audiovisual program be recorded, the control circuitry being further operable to cause the requested audiovisual program to be transmitted to a remote storage device over the data communication network through the network adapter and to be recorded at the remote storage device.

2. The device of claim 1, wherein the device is operable to receive a network request over the data communication network through the network adapter, where the network request is a request to record the audiovisual program.

3. The device of claim 1, wherein the command interface is further operable to receive input requesting that an audiovisual program stored at the remote storage device be replayed, the control circuitry being operable to cause the stored audiovisual program to be replayed from the remote storage device over the data communication network through the network adapter.

4. The device of claim 1, wherein the control circuitry transmits the requested audiovisual program to the remote storage device using a network file sharing protocol.

5. The device of claim 4, wherein the network file sharing protocol is a file transfer protocol, a server message block protocol, or a network file server protocol.

6. The device of claim 1, wherein the remote storage device is selected from two or more remote storage devices.

7. The device of claim 6, wherein the remote storage device is selected based on available storage capacity, or assigned priorities.

8. The device of claim 1, further comprising:
a solid state memory adapter operable to receive a solid state memory device, the solid state memory adapter being further operable to record the requested audiovisual program at the solid state memory device through the solid state memory adapter.

9. The device of claim 9, wherein the solid state memory adapter is operable to receive a removable solid state memory device.

10. The device of claim 1, wherein the device is a cellular telephone or a television.

11. The device of claim 1, wherein the data communication network comprises a local area network or a wide area network.

12. The device of claim 1, wherein the data communication network comprises a wireless network or a wired network.

13. A system comprising:
a first network addressable device, comprising,
a first video input controller operable to receive an audiovisual program,
a first video output controller coupled to communicate with the first video input controller, the first video output controller being operable to output a first video signal representing the audiovisual program,
a first command interface operable to receive input requesting that the audiovisual program be recorded,
a first network adapter operable to communicate an instruction to record the requested audiovisual program, and
a first control circuitry coupled to communicate with the first video input controller, the first video output controller, the first network adapter, and the first command interface;
a second network addressable device operable to receive the audiovisual program, the second network addressable device comprising a second network adapter and a second control circuitry coupled to communicate with the second network adapter, the second control circuitry being operable to receive the instruction to record the requested audiovisual program from the first network addressable device through the second network adapter;
a remote storage device that is remote from the first and from the second network addressable device;
a data communication network, the first and second network addressable device being addressable over the data communication network;
wherein the first control circuitry is operable to cause the requested audiovisual program to be transmitted to the remote storage device over the data communication network through the first network adapter and to be recorded at the remote storage device, the first control circuitry being further operable to forward the input request for recording the audiovisual program to the second network addressable device, and wherein the second control circuitry is operable to receive the input request for recording the requested audiovisual program and record the requested audiovisual program at the remote storage device, in response to the input request.

14. The system of claim 13, wherein the first command interface is operable to receive input requesting that an audiovisual program stored at the remote storage device be replayed, the first control circuitry being operable to replay the stored audiovisual program from the remote storage device over the data communication network through the first network adapter.

15. A method comprising:
receiving command input to record a requested audiovisual program at a first device, the requested audiovisual program being one of one or more audiovisual programs received at the first device, the first device having a first network adapter;
selecting one remote storage device from one or more remote storage devices, the remote storage device being remote from the first device, the first device being operable to communicate with the selected remote storage device through the network adapter;
determining in the first device whether to use the first device or a second device to record the requested audiovisual program, and recording at least a portion of the requested audiovisual program at the selected remote storage device using the first device, if the first device is used to record the requested audiovisual program;
selecting the second device from one or more remote devices that are remote from the first device, if the second device is used to record the requested audiovisual program, the second device having a second network adapter, the first device being operable to communicate the command input with the second device through the first network adapter and the second network adapter; and
recording at least a portion of the requested audiovisual program at the selected remote storage device using the second device, if the second device is used to record the requested audiovisual program.

16. The method of claim 15, wherein the remote storage device is remote from the second device, and the second device is operable to communicate with the selected remote storage device through the network adapter.

17. The method of claim 15 recording the portion of the requested audiovisual program comprises:
receiving the requested audiovisual program;
encoding the requested audiovisual program into a compressed digital format; and
storing the portion of the requested audiovisual program in compressed format as one or more files.

18. The method of claim 15, wherein recording the portion of the requested audiovisual program comprises:
transmitting the portion of the requested audiovisual program to the selected remote storage device using a network file sharing protocol; and
storing the portion of the requested audiovisual program at the selected remote storage device.

19. The method of claim 18, wherein the network file sharing protocol is a file transfer protocol, a server message block protocol, or a network file server protocol.

20. The method of claim 15, wherein selecting the remote storage device comprises selecting the remote storage device using the first device.

21. The method of claim 15, wherein selecting the remote storage device comprises selecting the remote storage device using the second device.

22. The method of claim 15, wherein selecting the remote storage device comprises:
selecting the remote storage device from the one or more remote storage devices based on available storage capacity for recording the requested audiovisual program.

23. The method of claim 22, wherein the one or more remote storage devices have assigned priorities, and selecting the remote storage device further comprises:
selecting the remote storage devices having the highest priority.

24. A computer program product tangibly embedded in a computer readable medium, the computer program product comprising instructions operable to cause data processing equipment to:
receive command input to record a requested audiovisual program at a first device, the requested audiovisual program being one of one or more audiovisual programs received at the first device, the first device having a first network adapter;
select one remote storage device from one or more remote storage devices, the remote storage device being remote from the first device, the first device being operable to communicate with the selected remote storage device through the network adapter;
determine in the first device whether to use the first device or a second device to record the requested audiovisual program, and send an instruction to record at least a portion of the requested audiovisual program at the selected remote storage device using the first device, if the first device is used to record the requested audiovisual program;
select the second device from one or more remote devices that are remote from the first device, if the second device is used to record the requested audiovisual program, the second device having a second network adapter, the first device being operable to communicate the command input with the second device through the first network adapter and the second network adapter; and
send an instruction to record at least a portion of the requested audiovisual program at the selected remote storage device using the second device, if the second device is used to record the requested audiovisual program.

25. The computer program product of claim 24, wherein the remote storage device is remote from the second device, and the second device is operable to communicate with the selected remote storage device through the network adapter.
